(19) United States
(12) Patent Application Publication
(10) Pub. No.: US 2025/0185044 A1
(43) Pub. Date: Jun. 5, 2025

(54) SYSTEMS AND METHODS FOR DEVICE-TO-DEVICE COMMUNICATIONS

(71) Applicant: ZTE CORPORATION, Shenzhen (CN)

(72) Inventors: Weiqiang DU, Shenzhen (CN); Wei LUO, Shenzhen (CN); Lin CHEN, Shenzhen (CN)

(73) Assignee: ZTE CORPORATION, Shenzhen (CN)

(21) Appl. No.: 19/045,011

(22) Filed: Feb. 4, 2025

Related U.S. Application Data
(63) Continuation of application No. PCT/CN2022/119460, filed on Sep. 16, 2022.

(51) Int. Cl. H04W 72/40; H04L 1/1829; H04W 24/04

(52) U.S. Cl. CPC H04W 72/40; H04L 1/1864; H04W 24/04

(57) ABSTRACT

The present disclosure relates to managing communications between a first wireless communication device and a second communication device, including communicating, by a first wireless communication device with a second wireless communication device, Sidelink (SL) communications, and determining, by the first wireless communication device, an anomaly state on a first carrier.

This application claims the benefit of priority under 35 U.S.C. § 120 as a continuation of PCT Patent Application No. PCT/CN2022/119460, filed on Sep. 16, 2022, the disclosure of which is incorporated herein by reference in its entirety.

### TECHNICAL FIELD

The disclosure relates generally to wireless communications and, more particularly, to an anomaly state in device-to-device communications.

### BACKGROUND

Sidelink (SL) communication refers to wireless radio communication between two or more User Equipments (UEs). In this type of communications, two or more UEs that are geographically proximate to each other can communicate without being routed to a Base Station (BS) or a core network. Data transmissions in SL communications are thus different from typical cellular network communications that include transmitting data to a BS and receiving data from a BS. In SL communications, data is transmitted directly from a source UE to a target UE through, for example the Unified Air Interface (e.g., PC5 interface) without passing through a BS.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

In some arrangements, systems, methods, apparatuses, and non-transitory computer-readable media relate to managing anomaly state in SL communications, including communicating, by a first wireless communication device with a second wireless communication device, SL communications and detecting, by the first wireless communication device, anomaly state on a first carrier.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1A is a diagram illustrating an example wireless communication network, according to various arrangements.

FIG. 1B is a diagram illustrating a block diagram of an example wireless communication system for transmitting and receiving downlink, uplink, and/or SL communication signals, according to various arrangements.

FIG. 2 illustrates an example scenario for SL communication, according to various arrangements.

FIG. 3 is a flow diagram illustrating an example method for managing SL communications, according to various arrangements.

FIG. 4 is a flow diagram illustrating an example method for managing SL communications, according to various arrangements.

FIG. 5 is a flow diagram illustrating an example method for managing SL communications, according to various arrangements.

FIG. 6 is a flow diagram illustrating an example method for managing SL communications, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

With the advent of wireless multimedia services, users' demand for high data rate and user experience continue to increase, which sets forth higher requirements on the system capacity and coverage of traditional cellular networks. In addition, public safety, social networking, close-range data sharing, and local advertising have gradually expanded the need for Proximity Services, which allow users to understand and communicate with nearby users or objects. The traditional BS-centric cellular networks have limited high data rate capabilities and support for proximity services. In this context, device-to-device (D2D) communications emerge to address the shortcomings of the BS-centric models. The application of D2D technology can reduce the burden of cellular networks, reduce battery power consumption of UEs, increase data rate, and improve the robustness of network infrastructure, thus meeting the above-mentioned requirements of high data rate services and proximity services. D2D technology is also referred to as Proximity Services (ProSe), unilateral/sidechain/SL communication, and so on.

To improve the reliability, data rate, latency of SL communications, Carrier Aggregation (CA) can be implemented for SL communications. In CA, two or more Component Carriers (CCs) are aggregated in order to support wider transmission bandwidths in the frequency domain. In some examples, a vehicle UE can simultaneously perform SL reception and transmission on one or multiple CCs. The arrangements disclosed herein relate to data split and data duplication based on CA.

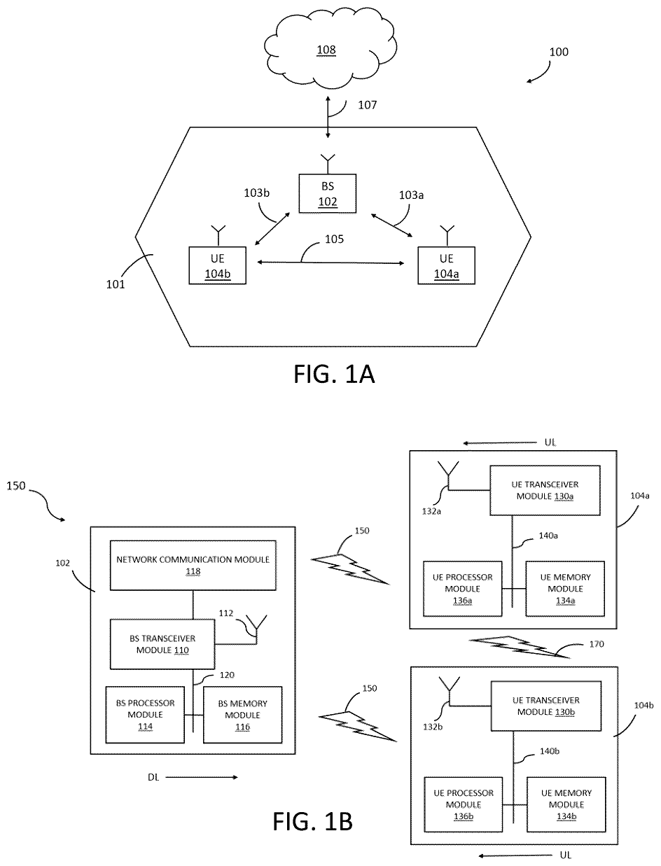

Referring to FIG. 1A, an example wireless communication network 100 is shown. The wireless communication network 100 illustrates a group communication within a cellular network. In a wireless communication system, a network side communication node or a BS can include a next Generation Node B (gNB), an E-UTRAN Node B (also known as Evolved Node B, eNodeB or eNB), a pico station, a femto station, a Transmission/Reception Point (TRP), an Access Point (AP), or so on. A terminal side node or a UE can include a device such as, for example, a mobile device, a smart phone, a cellular phone, a Personal Digital Assistant (PDA), a tablet, a laptop computer, a wearable device, a vehicle with a vehicular communication system, or so on. In FIG. 1A, a network side and a terminal side communication node are represented by a BS 102 and UEs 104a and 104b, respectively. In some arrangements, the BS 102 and UEs 104a/104b are sometimes referred to as “wireless communication node” and “wireless communication device,” respectively. Such communication nodes/devices can perform wireless communications.

In the illustrated arrangement of FIG. 1A, the BS 102 can define a cell 101 in which the UEs 104a and 104b are located. The UEs 104a and/or 104b can be moving or remain stationary within a coverage of the cell 101. The UE 104a can communicate with the BS 102 via a communication channel 103a. Similarly, the UE 104b can communicate with the BS 102 via a communication channel 103b. In addition, the UEs 104a and 104b can communicate with each other via a communication channel 105. The communication channels 103a and 104b between a respective UE and the BS can be implemented using interfaces such as an Uu interface, which is also known as Universal Mobile Telecommunication System (UMTS) air interface. The communication channel 105 between the UEs is a SL communication channel and can be implemented using a PC5 interface, which is introduced to address high moving speed and high density applications such as, for example, D2D communications, Vehicle-to-Vehicle (V2V) communications, Vehicle-to-Pedestrian (V2P) communications, Vehicle-to-Infrastructure (V2I) communications, Vehicle-to-Network (V2N) communications, or the like. In some instances, vehicle network communications modes can be collective referred to as Vehicle-to-Everything (V2X) communications. The BS 102 is connected to Core Network (CN) 108 through an external interface 107, e.g., an Iu interface.

In some examples, a remote UE (e.g., the UE 104b) that does not directly communicate with the BS 102 or the CN 108 (e.g., the communication channel link 103b is not established) communicates indirectly with the BS 102 and the CN 108 using the SL communication channel 105 via a relay UE (e.g., the UE 104a), which can directly communicate with the BS 102 and the CN 108 or indirectly communicate with the BS 102 and the CN 108 via another relay UE that can directly communicate with the BS 102 and the CN 108.

FIG. 1B illustrates a block diagram of an example wireless communication system for transmitting and receiving downlink, uplink and SL communication signals, in accordance with some arrangements of the present disclosure. In some arrangements, the system can transmit and receive data in a wireless communication environment such as the wireless communication network 100 of FIG. 1A, as described above.

The system generally includes the BS 102 and UEs 104a and 104b, as described in FIG. 1A. The BS 102 includes a BS transceiver module 110, a BS antenna 112, a BS memory module 116, a BS processor module 114, and a network communication module 118, each module being coupled and interconnected with one another as necessary via a data communication bus 120. The UE 104a includes a UE transceiver module 130a, a UE antenna 132a, a UE memory module 134a, and a UE processor module 136a, each module being coupled and interconnected with one another as necessary via a data communication bus 140a. Similarly, the UE 104b includes a UE transceiver module 130b, a UE antenna 132b, a UE memory module 134b, and a UE processor module 136b, each module being coupled and interconnected with one another as necessary via a data communication bus 140b. The BS 102 communicates with the UEs 104a and 104b via one or more of a communication channel 150, which can be any wireless channel or other medium known in the art suitable for transmission of data as described herein.

The system may further include any number of modules other than the modules shown in FIG. 1B. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from an antenna of one of the UEs 104a and 104b to an antenna of the BS 102 is known as an uplink transmission, and a wireless transmission from an antenna of the BS 102 to an antenna of one of the UEs 104a and 104b is known as a downlink transmission. In accordance with some arrangements, each of the UE transceiver modules 130a and 130b may be referred to herein as an uplink transceiver, or UE transceiver. The uplink transceiver can include a transmitter and receiver circuitry that are each coupled to the respective antenna 132a and 132b. A duplex switch may alternatively couple the uplink transmitter or receiver to the uplink antenna in time duplex fashion. Similarly, the BS transceiver module 110 may be herein referred to as a downlink transceiver, or BS transceiver. The downlink transceiver can include RF transmitter and receiver circuitry that are each coupled to the antenna 112. A downlink duplex switch may alternatively couple the downlink transmitter or receiver to the antenna 112 in time duplex fashion. The operations of the transceivers 110 and 130a and 130b are coordinated in time such that the uplink receiver is coupled to the antenna 132a and 132b for reception of transmissions over the wireless communication channel 150 at the same time that the downlink transmitter is coupled to the antenna 112. In some arrangements, the UEs 104a and 104b can use the UE transceivers 130a and 130b through the respective antennas 132a and 132b to communicate with the BS 102 via the wireless communication channel 150. The wireless communication channel 150 can be any wireless channel or other medium known in the art suitable for downlink and/or uplink transmission of data as described herein. The UEs 104a and 104b can communicate with each other via a wireless communication channel 170. The wireless communication channel 170 can be any wireless channel or other medium suitable for SL transmission of data as described herein.

Each of the UE transceiver 130a and 130b and the BS transceiver 110 are configured to communicate via the wireless data communication channel 150, and cooperate with a suitably configured antenna arrangement that can support a particular wireless communication protocol and modulation scheme. In some arrangements, the UE transceiver 130a and 130b and the BS transceiver 110 are configured to support industry standards such as the Long Term Evolution (LTE) and emerging 5G and 6G standards, or the like. It is understood, however, that the present disclosure is not necessarily limited in application to a particular standard and associated protocols. Rather, the UE transceiver 130a and 130b and the BS transceiver 110 may be configured to support alternate, or additional, wireless data communication protocols, including future standards or variations thereof.

The processor modules 136a and 136b and 114 may be each implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, methods and algorithms described in connection with the arrangements disclosed herein may be embodied directly in hardware, in firmware, in a software module executed by processor modules 114 and 136a and 136b, respectively, or in any practical combination thereof. The memory modules 116 and 134a and 134b may be realized as RAM memory, flash memory, ROM memory, EPROM memory, EEPROM memory, registers, a hard disk, a removable disk, a CD-ROM, or any other form of storage medium known in the art. In this regard, the memory modules 116 and 134a and 134b may be coupled to the processor modules 114 and 136a and 136b, respectively, such that the processors modules 114 and 136a and 136b can read information from, and write information to, memory modules 116 and 134a and 134b, respectively. The memory modules 116, 134a, and 134b may also be integrated into their respective processor modules 114, 136a, and 136b. In some arrangements, the memory modules 116, 134a, and 134b may each include a cache memory for storing temporary variables or other intermediate information during execution of instructions to be executed by processor modules 116, 134a, and 134b, respectively. Memory modules 116, 134a, and 134b may also each include non-volatile memory for storing instructions to be executed by the processor modules 114 and 136a and 136b, respectively.

The network interface 118 generally represents the hardware, software, firmware, processing logic, and/or other components of the BS 102 that enable bi-directional communication between BS transceiver 110 and other network components and communication nodes configured to communication with the BS 102. For example, the network interface 118 may be configured to support internet or WiMAX traffic. In a typical deployment, without limitation, the network interface 118 provides an 802.3 Ethernet interface such that BS transceiver 110 can communicate with a conventional Ethernet based computer network. In this manner, the network interface 118 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 118 can allow the BS 102 to communicate with other BSs or core network over a wired or wireless connection.

In some arrangements, each of the UEs 104a and 104b can operate in a hybrid communication network in which the UE communicates with the BS 102, and with other UEs, e.g., between 104a and 104b. As described in further detail below, the UEs 104a and 104b support SL communications with other UE's as well as downlink/uplink communications between the BS 102 and the UEs 104a and 104b. In general, the SL communication allows the UEs 104a and 104b to establish a direct communication link with each other, or with other UEs from different cells, without requiring the BS 102 to relay data between UEs.

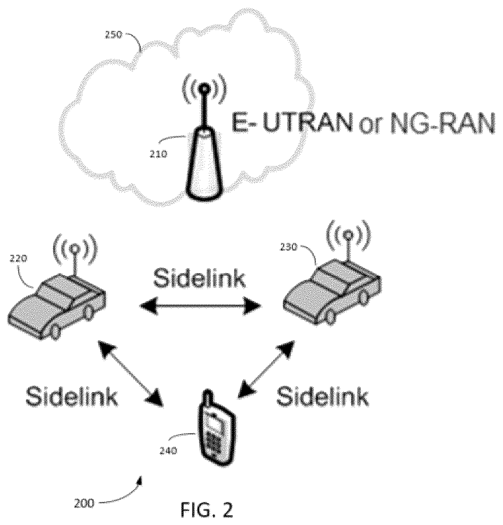

FIG. 2 is a diagram illustrating an example system 200 for SL communication, according to various arrangements. As shown in FIG. 2, a BS 210 (such as BS 102 of FIG. 1A) broadcasts a signal that is received by a first UE 220, a second UE 230, and a third UE 240. The UEs 220 and 230 in FIG. 2 are shown as vehicles with vehicular communication networks, while the UE 240 is shown as a mobile device. As shown by the SLs, the UEs 220-240 are able to communicate with each other (e.g., directly transmitting and receiving) via an air interface without forwarding by the base station 210 or the core network 250. This type of V2X communication is referred to as PC5-based V2X communication or V2X SL communication.

As used herein, when two UEs 104a or 104b are in SL communications with each other via the communication channel 105/170, the UE that is transmitting data to the other UE is referred to as the transmission (TX) UE, and the UE that is receiving said data is referred to as the reception (RX) UE.

For a UE performing SL communications using multiple carriers, one or more of the carriers may not be suitable for performing SL communications. In this case, the UE monitors the carrier state to check whether the current carrier is still suitable for performing SL communications and attempt to recover the SL carrier if anomaly state is detected. The UE can report the anomaly state of at least one or more carrier to the BS.

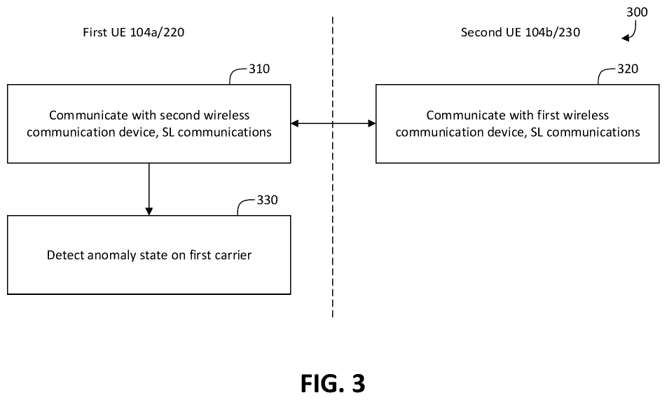

FIG. 3 is a flowchart diagram illustrating an example method 300 for detecting an anomaly state in CA-based SL wireless communications, according to various arrangements. Referring to FIGS. 1A-3, the method 300 can be performed by a first UE (e.g., the UE 104a/220) and a second UE (e.g., the UE 104b/230). Communication via the SL wireless communication channel 170 or SL network is shown as cross the dashed line.

In some arrangements, the anomaly state includes Radio Link Failure (RLF). In some examples, a UE such as the first UE can detect the anomaly state for a carrier in the manner described herein, and as a response triggers RLF on that carrier directly. In some examples, in response to detecting the anomaly state as described, the first UE determines or considers that the RLF is detected on the first carrier upon determining that the carrier cannot be recovered from the anomaly state.

At 310, the first UE communicates with the second UE SL communications. At 320, the second UE communicates with the first UE SL communications. For example, the first UE and the second UE are sending and receiving signals and data to each other. At 330, the first UE determines anomaly state on the first carrier.

In some arrangements the first UE report at least one of following to the network, in response to that the first UE determining the anomaly state on the first carrier: 1) identification of carrier, where this identification can be at least one of: carrier ID of the carrier, carrier index of the carrier, or frequency of the carrier; and/or 2) anomaly state associated to the reported carrier.

In some arrangements, the first UE determines that the anomaly state is detected on the first carrier in response to detecting an amount of absent feedback information on the first carrier reaches a maximum value (e.g., a predetermined threshold). The absent feedback information includes at least one of absent Physical Sidelink Feedback Channel (PSFCH) reception or absent Hybrid Automatic Repeat Request (HARQ) feedback reception. In some arrangements, the maximum value can be configured by at least one of the network (e.g. the BS), a second UE, or so on.

For example, the first UE determines that the anomaly state is detected on the first carrier in response to detecting a number of absent PSFCH reception on at least one PSFCH reception resource (e.g., occasion) for the first carrier reaches a maximum value. That is, the first UE detects that the anomaly state has detected on the first carrier in response to determining that the maximum number of absent PSFCH reception on at least one PSFCH reception resource for the first carrier in communicating with the second UE via the SL connection has been reached. For example, the first UE determines the anomaly state on the first carrier in response to determining a number of absent HARQ feedback on at least one HARQ feedback resource (e.g., occasion) for the first carrier reaches a maximum value. That is, the first UE detects that the anomaly state has detected on the first carrier in response to determining that the maximum number of absent HARQ feedback on the HARQ feedback resource for the first carrier in communicating with the second UE via the SL connection has been reached. For example, the first UE determines the anomaly state on the first carrier in response to determining that positive-negative acknowledgement is selected and that the number of absent PSFCH reception on at least one PSFCH reception resource for the first carrier reaches the maximum value. That is, the first UE detects that the anomaly state has detected on the first carrier in response to determining that the maximum number of absent PSFCH reception is absent on the PSFCH reception resource for the first carrier in communicating with the second UE via the SL connection has been reached, where the positive-negative acknowledgement is selected, e.g., by at least one of the first UE, the second UE, or the BS. For example, the first UE determines the anomaly state on the first carrier in response to determining that negative-only acknowledgement is selected and that the number of absent PSFCH reception on at least one PSFCH reception resource for the first carrier reaches the maximum value. That is, the first UE detects that the anomaly state has detected on the first carrier in response to determining that the maximum number of absent PSFCH reception is absent on the PSFCH reception resource for the first carrier in communicating with the second UE via the SL connection has been reached, where the negative-only acknowledgement is selected, e.g., by at least one of the first UE, the second UE, or the BS.

In some arrangements, the first UE determines that the anomaly state is detected on the first carrier in response to determining that a ratio of an amount of absent feedback information on the first carrier to an amount of intended feedback information on the first carrier reaches a maximum value (e.g., a predetermined threshold). The ratio can include at least one of a ratio of a number of absent PSFCH receptions on at least one PSFCH reception resource for the first carrier to a number of intended PSFCH receptions on the at least one PSFCH reception resource, or a ratio of a number of absent HARQ feedback on at least one HARQ feedback resource for the first carrier to the number of intended HARQ feedback on the at least one HARQ feedback resource.

For example, the first UE detects that the anomaly state has been detected on the first carrier in response to determining that a ratio of a number of absent PSFCH receptions on at least one PSFCH reception resource for the first carrier to the number of intended PSFCH receptions on the at least one PSFCH reception resource reaches a maximum value (e.g. PSFCH ratio threshold), and positive-negative acknowledgement is selected. That is, the first UE detects that the anomaly state has detected on the first carrier in response to determining that the ratio of number of absent PSFCH reception on the first carrier to the number of intended PSFCH receptions on the first carrier reaches a threshold, where positive-negative acknowledgement is selected. For groupcast and in the example in which positive-negative acknowledgement is used, each RX UE (e.g., the first UE) sends the HARQ feedback on different PSFCH resources (e.g., the at least one PSFCH reception resource). For a given transmission, the intended PSFCH reception means TX UE (e.g., the second UE) is intended to receives N PSFCH receptions (intended HARQ feedback) on N PSFCH resources, where N is the group size. The group size is the number of RX UEs within the group.

For example, the first UE detects that the anomaly state has detected on the first carrier in response to determining that a ratio of a number of absent HARQ feedback on at least one HARQ feedback resource for the first carrier to the number of intended HARQ feedback on the at least one HARQ feedback resource reaches a HARQ feedback ratio threshold, and positive-negative acknowledgement is selected. That is, the first UE detects that the anomaly state has detected on the first carrier in response to determining that the ratio of number of absent HARQ feedback to the number of intended HARQ feedback is higher than a maximum value (e.g., a threshold), where positive-negative acknowledgement is selected. For groupcast and in the example in which positive-negative acknowledgement is used, each RX UE (e.g., the first UE) sends the HARQ feedback on different PSFCH resources (e.g., the at least one HARQ feedback resource). For a given transmission, TX UE (e.g., the second UE) is intended to receives NPSFCH receptions (intended HARQ feedback) on N HARQ feedback resources, where N is the group size. The group size is the number of RX UEs within the group.

For example, the first UE detects that the anomaly state has been detected on the first carrier in response to determining that a ratio that assess business of the channel on the first carrier exceeds a threshold. For example, the first UE can detect that a Channel Busy Ratio (CBR) of a resource pool on the first carrier is higher than a configured threshold, where the CBR indicates the channel congestion (e.g., the greater the CBR, the greater the channel congestion). The CBR can include a ratio of sub-channels with signal strength (e.g., measured using Received Signal Strength Indicator (RSSI) higher than a threshold to a total number of sub-channels on the carrier. The first UE can determine the CBR on the first carrier.

For example, the first UE detects that the anomaly state has been detected at least on the first carrier or on a destination in response to determining a number of retransmissions for a destination reaches a retransmission maximum value. In some examples, the destination identifies a service, where a UE having interests on this service receives the data having the destination. The destination is identified by the destination layer 2 ID. In other words, the destination can also identify one or more UEs. For example, the SL Radio Link Control (RLC) entity residing in at least one of the BS, the first UE, or the second UE can indicate to the first UE that the maximum number of retransmissions for a specific destination has been reached. For example, the MAC entity (e.g., an SL MAC entity for a destination) residing in at least one of the BS, the first UE, or the second UE can indicate to the first UE that the maximum number of retransmissions for a specific destination has been reached.

For example, the first UE detects that the anomaly state has been detected on the first carrier in response to determining that a RRC timer (e.g., T400) for the destination has expired. The timer T400 is initiated in response to transmission of RRC reconfiguration message for SL and stopped in response to receiving an RRC reconfiguration failure message for SL or RRC reconfiguration complete message for SL. In one example, the first UE considers that the anomaly state has been detected on the carrier associated the channel transmitting the RRC message triggering the timer (e.g., T400).

For example, the first UE detects that the anomaly state has been detected on the first carrier in response to determining that a number of consecutive HARQ Discontinuous Transmission (DTX) for a destination reaches a HARQ DTX maximum value. The Media Access Control (MAC) entity residing in at least one of the BS, the first UE, or the second UE can indicate to the first UE the maximum number of consecutive HARQ DTX on the first carrier for a destination has been reached.

For example, the first UE detects that the anomaly state has been detected on the first carrier in response to determining that integrity for at least one Radio Bearer (RB) (e.g., SL-Signaling Radio Bearer 2 (SL-SRB2) or SL-SRB3) for a destination has failed. A SL Packet Data Convergence Protocol (PDCP) entity residing on one or more of the first UE, the second UE, and the BS can send to the first UE an integrity check failure indication indicating integrity failing of at least one of SL-SRB2 or SL-SRB3 for a destination. In one example, the first carrier is the carrier selected for this radio bearer. In one example, the first carrier is the carrier selected for the logical channel associated with this radio bearer.

For example, the first UE detects that the anomaly state has been detected on the first carrier in response to determining that the maximum transmission number of recovery signaling has been reached. For example, the first UE detects that the anomaly state has been detected on the first carrier in response to determining that the first UE does not receives the maximum number of response signaling. For example, the first UE detects that the anomaly state has detected on the first carrier in response to determining that the first UE has not received the response signaling.

The first UE determines that the anomaly state is detected on the destination in response to determining at least one of: receiving indication from a sidelink RLC entity indicating that the maximum number of retransmissions for a specific destination has been reached, upon receiving a notification for or upon otherwise determining that RRC reconfiguration timer (e.g., T400) has expired for a specific destination, upon receiving indication from a MAC entity indicating that the maximum number of consecutive HARQ feedback absent for a specific destination has been reached, or upon receiving integrity check failure indication from an SL PDCP entity concerning SL RB (e.g. SL-SRB2 or SL-SRB3) for a specific destination. In some arrangements, the recovery procedure for the destination is triggered by the first UE determining the anomaly state on the destination and determining that no carrier meets a carrier selection condition (e.g., no carrier can be selected as candidate carrier when carrier selection or re-selection is triggered) for communicating with a destination (e.g., the second UE).

In some arrangements, in response to the first UE determining that the anomaly state is detected on the destination, the first UE performs at least one of: considers or determines that the RFL is detected on the destination, the anomaly state is detected on the carrier associated to the destination, the anomaly state is detected on the carrier associated to the radio bearer of the RRC message triggering RRC timer (e.g. T400), the anomaly state is detected on the carrier on which the maximum number of consecutive HARQ feedback absent is reached, the anomaly state is detected on the carrier associated to radio bearer occurring integrity check failure, or the anomaly state is detected on the carrier associated to radio bearer on which the maximum number of RLC entity retransmissions for a specific destination has been reached.

In some arrangements, the first UE considers RLF is detected on first carrier, in response to determining that the first carrier be not recovered from anomaly state. In one embodiment, UE considers RLF is detected on destination, if all carriers configured for this destination cannot be recovered from the anomaly state.

In some examples, one or more of the maximum number of retransmissions for a specific destination, the HARQ DTX maximum value, the maximum number of consecutive HARQ DTX, the maximum transmission number of recovery signaling, or so or can be configured for the first UE by (e.g., received by the first UE from) the BS or the second UE.

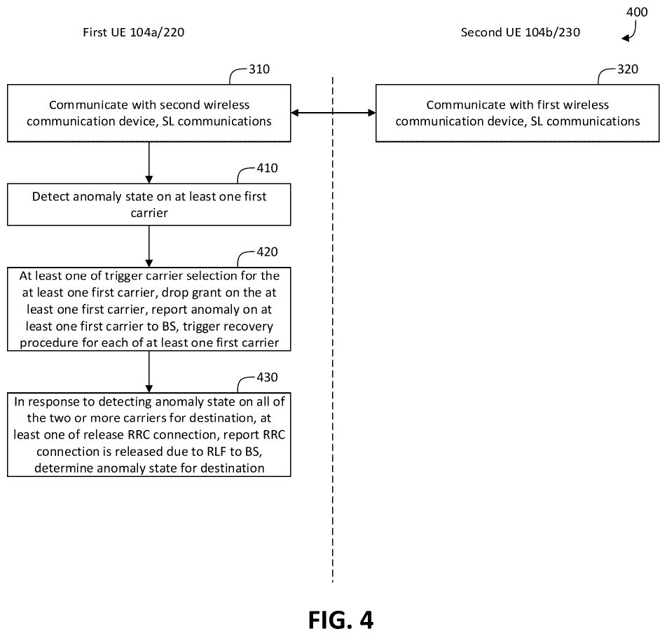

FIG. 4 is a flowchart diagram illustrating an example method 400 for detecting anomaly state, according to various arrangements. Referring to FIGS. 1A-4, the method 400 can be performed by a first UE (e.g., the UE 104a/220) and a second UE (e.g., the UE 104b/230). Communication via the SL wireless communication channel 170 or SL network is shown as cross the dashed line.

At 310, as described, the first UE communicates with the second UE SL communications. At 320, as described, the second UE communicates with the first UE SL communications. At 410, the first UE determines anomaly state. The anomaly state for each of the at least one carrier or the destination can be determined based on, for example, the manner in which anomaly state for the first carrier or destination is determined at 330.

In response to determining that the anomaly state is detected on the at least one first carrier or the destination, the first UE can perform at 420 at least one of triggering carrier selection or reselection, dropping grant (e.g., sidelink grant) configured for each of the at least one first carrier, or reporting the anomaly state for each of the at least one first carrier to the network (e.g., the BS), or triggering the recovery procedure for carrier for which the anomaly state is detected, triggering a recovery procedure for the destination on which the anomaly state is detected, or triggering a reporting procedure. In some arrangements, in response to triggering the reporting procedure, the first UE reports at least one of following to the second UE: the anomaly state of the carrier, the anomaly state of the destination, recovery of the carrier on which the anomaly state is detected, the recovery of the destination on which the anomaly state is detected, recovery failure of the carrier on which the anomaly state is detected, upon determining that the recovery procedure is a failure, the recovery failure of the destination on which the anomaly state is detected upon determining that the recovery procedure is a failure, recovery success of the carrier on which the anomaly state is detected upon demining that the recovery procedure is a failure, the recovery success of the destination on which the anomaly state is detected, upon demining that the recovery procedure is a failure, the identification of the carrier on which the anomaly state is detected, or the identification of the destination on which the anomaly state is detected.

In response to determining that the anomaly state is detected on all of the two or more carriers for a destination (e.g., the second UE), the first UE at 430 can perform at least one of releasing the RRC connection with the destination, reporting to the network (e.g., the BS) that the RRC connection with the destination has been released due to anomaly state has been detected on all carriers, determining that radio link failure is detected for the destination associated to these destination.

In some arrangements, the first UE performs at least one of following in response to the first UE triggers the recovery procedure for each of the at least one first carrier: 1) start a timer; 2) transmit the recovery signaling; 3) receiving the response signaling; 4) receiving an indication from a second wireless device (e.g., peer UE, network)

In some arrangements in which the first UE is not configured to use multiple carriers (e.g., CA is not used) and in response to that the maximum number of consecutive HARQ DTX for a specific destination (e.g., the second UE) has been reached, the first UE determines that anomaly state is detected for that destination.

In some arrangements in which the first UE releases the PC5 RRC connection of this destination in response to determining that anomaly state of all carriers used for this destination cannot be recovered.

In some arrangements in which the first UE releases the PC5 RRC connection in response to determining that receiving an indication of releasing one PC5 RRC connection for a specific destination from the network (e.g., the BS).

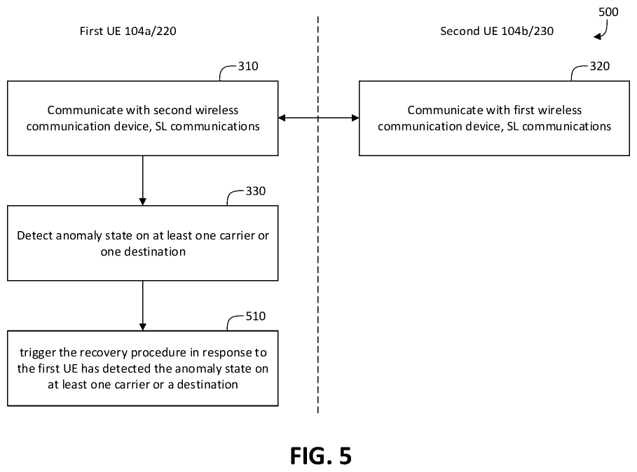

FIG. 5 is a flowchart diagram illustrating an example method 500 for detecting anomaly state, according to various arrangements. Referring to FIGS. 1A-5, the method 500 can be performed by a first UE (e.g., the UE 104a/220) and a second UE (e.g., the UE 104b/230). Communication via the SL wireless communication channel 170 or SL network is shown as cross the dashed line.

At 310, as described, the first UE communicates with the second UE SL communications, in a CA scenario. At 320, as described, the second UE communicates with the first UE SL communications. For example, the first UE and the second UE are sending and receiving signals and data to each other. At 330, as described, the first UE determines anomaly state on the first carrier or the destination. In some examples, the first UE determines that the RLF is detected on the second UE with a destination in response to determining that all of the two or more carriers cannot be recovered.

At 510, the first UE triggers the recovery procedure in response to the first UE has detected the anomaly state on at least one carrier or a destination.

In some arrangements, in response to triggering the recovery procedure, the first UE performs at least one of following: starting a timer, transmitting the recovery signaling, receiving the response signaling, receiving the indication signaling, or determining the recovery procedure is a success or failure. In some arrangements, the value of the timer is configured by the network.

For example, in response to determining that the recovery procedure is triggered due to the anomaly state being detected on one carrier, the recovery signaling is transmitted on the carrier on which the anomaly state is detected.

For example, in response to determining that the recovery procedure is a success, the first UE stops the timer.

For example, in response to determining that the recovery procedure is a failure, the first UE stops the timer.

For example, in response to determining that the recovery procedure is triggered due to the anomaly state being detected on one carrier, and in response to determining that the recovery procedure is a success, the first UE considers or determines that the carrier is recovered from anomaly state. For example in response to determining that if the recovery procedure is triggered due to the anomaly state being detected on one carrier, and in response to determining that the recovery procedure is a failure, the first UE considers or determines that the carrier cannot be recovered from the anomaly state.

For example, in response to determining that the recovery procedure is triggered due to the anomaly state being detected on one destination, and in response to determining that the recovery procedure is a success, the first UE considers or determines that the connection of this destination is recovered from the anomaly state. For example, in response to determining that the recovery procedure is triggered due to the anomaly state being detected on a destination, and in response to determining that the recovery procedure is a failure, the first UE considers or determines that the connection of this destination cannot be recovered from the anomaly state.

For example, the first UE transmit a first number (e.g., N) of anomaly state recovery signaling. In some example, the value of first number can be configured by network.

For example, the first UE considers the recovery procedure is success in response to at least one of following: the timer has expired, receives the anomaly state response signaling, receives the second number (e.g., M, M is an integer) of anomaly state response signaling, the third number of received response signaling reaches a configured threshold, determines that the timer initiated responsive to the recovery procedure being triggered has expired, receives the anomaly state response signaling while the timer has not expired, receives the second number of the anomaly state response signaling, the second number reaching than a configured maximum value while the timer has not expired, or determines that the timer initiated responsive to the recovery procedure being triggered has expired while the timer has not expiry.

For example, the first UE considers the recovery procedure is failure in response to at least one of following: the timer has expired, does not receives the response signaling, does not receives the second number (e.g., M, where M is an integer) of response signaling, the third number of received response signaling is less than a configured threshold.

In some arrangements, in response to the recovery procedure being triggered, the first UE receives an indication signaling, receiving the indication includes at least one of receiving, by the first UE from a second wireless device (e.g., the BS, or the peer UE), a SL carrier list including this first carrier, receiving, by the first UE from a network (e.g., the BS), a first activation indication indicating activating the first carrier, receiving, by the first UE from the network, a first recovery indication indicating recovering the first carrier, receiving, by the first UE from a peer UE (e.g., the second UE), a second activation indication indicating activating the first carrier, or receiving, by the first UE from the second UE, a second recovery indication indicating recovering the first carrier. In some arrangements, in response to the first UE receiving the indication signaling, the first UE considers or determines that the recovery procedure is success.

In some arrangements, the first UE receives an indication indicating releasing the connection with the destination from network.

For example, the first UE determines that the anomaly state on the first carrier has been recovered in response to the first UE determining that a timer initiated responsive to determining the anomaly state on the first carrier has expired. For example, the first UE starts a timer upon anomaly state is detected on the first carrier, and in response to determining that the timer expired, the first UE considers the first carrier is recovered from anomaly state.

In some examples, in response to the first UE detecting anomaly state on the first carrier, the first UE triggers a recovery procedure. Upon the recovery procedure is triggered, the first UE transmits an anomaly state recovery signaling to a peer UE (e.g., the second UE). After receiving the anomaly state recovery response signaling from the peer UE, the first UE determines that the anomaly state for the first carrier has been recovered.

In some examples, the response signaling can include at least one of HARQ feedback, MAC CE, RRC signaling, RRC Re-establishment signaling. Thus, in some arrangements, in response to determining the anomaly state on the first carrier, the first UE transmits at least one anomaly state recovery signaling to the second UE. The first UE receives from the second UE at least one anomaly state response signaling. The first UE determines that the anomaly state on the first carrier has been recovered in response to receiving the at least one anomaly state response signaling. In some example in which the first UE does not receive the response signaling, the first UE considers that the anomaly state on the first carrier cannot be recovered.

For example, the recovery signaling can be at least one of Sidelink Control Information (SCI), RRC signaling, MAC CE, RRC re-establishment request signaling, discovery message, discovery request message, discovery solicitation message.

For example, the response signaling can be at least one of a RRC signaling, a MAC CE a HARQ feedback, a RRC re-establishment signaling, discovery response message.

In some examples, in response to the first UE detecting anomaly state on the first carrier, the first UE triggers a recovery procedure. Upon the recovery procedure is triggered, the first UE transmits a first number (e.g., N) of anomaly state recovery signaling to a peer UE (e.g., the second UE). In some example, the value of first number can be configured by network. After receiving at least a second number (e.g., M) of anomaly state recovery response signaling from the peer UE, the first UE determines that the anomaly state for the first carrier has been recovered. In some examples, the value of second number can be configured by network. In response to the first UE receiving a third number of anomaly state response signaling, the third number is less than a second number, the first UE determines at least one of: anomaly state cannot be recovered. The first number N and the second number M can be integers received from at least one of the network (e.g., the BS) or predetermined. Thus, in some arrangements, in response to determining the anomaly state on the first carrier, the first UE transmits a first number (e.g., N) of at least one anomaly state recovery signaling to the second UE. The first UE receives from the second UE a second number at least one anomaly state response signaling. In response to determining that the second number reaches a maximum value (e.g., M), the first UE determines that the anomaly state on the first carrier has been recovered. In response to determining that the second number failing to reach the maximum value (e.g., M), the first UE considers the carrier cannot be recovered from anomaly state. In some example, The value of maximum value can be configured by network.

In some arrangements, the first UE triggers a recovery procedure. Upon determining that the recovery procedure being triggered, the first UE transmits a first number (e.g., N) of at least one anomaly state recovery signaling to the second UE with a first period (e.g., K millisecond). In some arrangements, the transmission period can be controlled by a timer, for example, in response to the recovery procedure being triggered, the first UE starts a first timer. In response to determining that the first timer has expired, the first UE retransmits the recovery signaling and re-start the first timer. In response to determining that the maximum transmission number of recovery signaling has been reached, the first UE stops the first timer.

In some arrangements, in response to the recovery procedure being triggered, the first UE starts a first timer. In response to determining that the first timer has expired, the first UE considers that the carrier cannot be recovered. In response to the first UE receiving the response signaling, the first UE stops the timer. In response to the first UE receiving the response signaling, the first UE considers the carrier is recovered from the anomaly state.

In some arrangements, in response to determining that the recovery procedure is initiated due to the anomaly state is detected on a carrier, and in response to determining that the recovery procedure is a failure, the first UE considers that the carrier cannot be recovered

In response to the first UE considers that the carrier cannot be recovered, the first UE performs at least one of: 1) Considering or determining that the RLF is detected on this carrier; 2) dropping the SL grant on this carrier; 3) reporting the information including the carrier cannot be recovered to the network; or 4) reporting the information including identification of the carrier which cannot be recovered to the network.

In some arrangements, in response to determining that the recovery procedure is initiated due to the anomaly state being detected on a carrier, and in response to determining that the recovery procedure is a success, the first UE considers the carrier is recovered from the anomaly state.

In response to the first UE considering or determining that the carrier is recovered from the anomaly state, the first UE performs at least one of: 1) reporting the information including the carrier is recovered to the network; or 2) reporting the information including identification of the carrier which is recovered to the network.

In some arrangements, in response to the first UE considering or determining that all carriers associated to one destination cannot be recovered, the first UE performs at least one of: 1) releasing the RRC connection of this destination; 2) reporting the release of the destination's RRC connection to network; or 3) Reporting to the network the layer 2 ID of the destination which cannot been recovered.

In some arrangements, in response to the recovery procedure being triggered, the first UE starts a first timer. In response to determining that the first timer has expired and that the second number of received response signaling is less than a threshold (e.g., a maximum number), the first UE determines that recovery procedure is a failure. In response to determining that the first timer is running and the second number of received response signaling reaches a threshold (e.g., a maximum number), the first UE determines that recovery procedure is a failure. In response to the first UE receives the second number of response signaling and the second number reaches the threshold, the first UE performs at least one of: considering or determining that the recovery procedure is a failure or stopping the timer.

In some arrangements, in response to the recovery procedure being triggered, the first UE starts a first timer. In response to determining that the first timer has expired and that the second number of received response signaling is less than a threshold (e.g., the maximum number), the first UE determines that recovery procedure is a failure.

In some arrangement, the value of first timer can be configured by network.

In some arrangement, the value of second timer can be configured by network.

In some arrangements, in response to the first UE determining that the carrier cannot be recovered, the first UE reports the carrier cannot be recovered from anomaly state to network.

In some arrangements, the first UE receives from the network (e.g., the BS) at least one of the value of first number for recovery signaling, the value of second number for response signaling, the value of first period for recovery signaling, the value of first timer for transmission of recovery signaling, the priority of recovery signaling, the priority of response signaling, the latency bound of recovery signaling, the HARQ feedback attribute (e.g., HARQ enable or disable) of recovery signaling, the maximum retransmission number of recovery signaling, the latency bound of response signaling, the HARQ feedback attribute (e.g., HARQ enable or disable) of response signaling, the maximum retransmission number of response signaling, the value of transmission period for recovery signaling, and so on.

In some examples, in response to determining that the anomaly state for the first carrier is recovered, the first UE reports anomaly state recovery on the first carrier to the network (e.g., the BS). In some examples, the first UE starts a timer upon anomaly state is detected on the first carrier, and in response to determining that the timer expired, the first UE determines the anomaly state with respect to the destination (e.g., the second UE). In response to determining that no carrier meets a carrier selection condition (e.g., no carrier can be selected when carrier selection or re-selection is triggered) for communicating with a destination (e.g., the second UE), the first UE performs at least one of: determining that the anomaly state is detected on the destination, or reporting the information including no carrier meets a carrier selection condition to the network.

In some arrangements, in response to the first UE determining that the anomaly state is detected on the destination, the first UE performs at least one of: 1) reporting identification of destination to the network (this identification can be at least one of: layer2 ID or destination index); 2) reporting the anomaly state associated with the reported destination to the network; or 3) triggering the carrier selection or reselection.

In some arrangements, in response to determining that the recovery procedure is triggered due to the anomaly state being detected on a destination, and in response to determining that recovery procedure is a failure, the first UE considers or determines that the destination cannot be recovered from anomaly state. In response to the first UE determining that the destination cannot been recovered from anomaly state, the first UE performs at least one of: 1) determining or considering that the RLF is detected on this destination; 2) releasing the connection of the destination: 3) reporting the information including the destination cannot be recovered from the anomaly state to network; 4) reporting the information including the RLF of the destination to the network; and 5) reporting the information including the recovery for the destination is a failure.

In some arrangements, in response to determining that the recovery procedure is triggered due to the anomaly state being detected on a destination, and in response to determining that recovery procedure is a success, the first UE determines or considers that the destination is recovered from the anomaly state. In response to the first UE determining or considering that the destination is recovered from anomaly state, the first UE performs at least one of: 1) reporting the information including the destination being recovered from the anomaly state to network; 2) reporting the information including the layerL2 ID associated with the destination which is recovered from the anomaly state; 3) reporting the information including the recovery for the destination is a success.

In some arrangements, after receiving the SL grant, the first UE performs Logical Channel Prioritization (LCP) to generate MAC Protocol Data Units (PDU). The first UE does not use the SL grant belonging to the first carrier on which anomaly state is detected to transmit any data except for sending and receiving recovery signaling. In other words, in some examples, only the recovery signaling can be transmitted by the first UE on the carrier on which anomaly state is detected. During LCP, in response to determining that the anomaly state is not detected on a carrier on which the SL grant is configured, a destination having data object that satisfy one or more of following condition is selected: data object is available for transmission; bucket size>0, in case there is any data object having bucket size>0; sl-configuredGrantType1Allowed (indicating whether the data object is allowed to use configured grant type1), if configured, is set to true in case the SL grant is a Configured Grant Type 1; sl-AllowedCG-List (indicating whether the data object is allowed to use the specific configured grant), if configured, includes the configured grant index associated to the SL grant; and sl-HARQ-FeedbackEnabled (indicating the HARQ attribute of the data object, i.e. HARQ enable or disable) is set to disabled, if PSFCH is not configured for the SL grant associated to the SCI. In some examples, sl-configuredGrantType1Allowed is a parameter used to set a configured grant Type 1 to be used for SL. In some examples, sl-AllowedCG-List is a parameter used to set the allowed configured grant(s) for SL transmission. In some examples, sl-HARQ-FeedbackEnabled is a parameter used to determine whether the logical channel is allowed to be multiplexed with logical channel(s) with sl-HARQ-FeedbackEnabled.

In some arrangements, the data object can be at least one of Logical Channel (LCH) such as a SL LCH, MAC CE, recovery signaling, response signaling, or destination, sidelink radio bearer.

In some arrangements, during LCP, the data object used by first UE for selecting the destination having the data object should meet at least one condition-A for a SL grant.

In some arrangements, during LCP, the destination having the data object is selected for transmission if the data object meet at least one condition-A for a SL grant.

In some arrangements, during LCP, the data object is selected for transmission by first UE meets at least one of following condition-A for a SL grant.

In some arrangements, the condition-A can be at least one of following: if anomaly state is not detected on the carrier including the SL grant, data object is available for transmission; if anomaly state is not detected on the carrier including the SL grant, bucket size>0, in case there is any logical channel having bucket size>0; if anomaly state is not detected on the carrier including the SL grant, sl-configuredGrantType1Allowed, if configured, is set to true in case the SL grant is a Configured Grant Type 1; if anomaly state is not detected on the carrier including the SL grant, sl-AllowedCG-List, if configured, includes the configured grant index associated to the SL grant; if anomaly state is not detected on the carrier including the SL grant, sl-HARQ-FeedbackEnabled is set to disabled, if PSFCH is not configured for the SL grant associated to the SCI; if anomaly state is detected on the carrier including the SL grant, the data object is recovery signaling triggered by the anomaly state detected on this carrier; if anomaly state is detected on the carrier including the SL grant, the data object is response signaling in response to a recovery signaling by the anomaly state detected on this carrier. In some examples, sl-configuredGrantType1Allowed is a parameter used to set a configured grant Type 1 to be used for SL. In some examples, sl-AllowedCG-List is a parameter used to set the allowed configured grant(s) for SL transmission. In some examples, sl-HARQ-FeedbackEnabled is a parameter used to determine whether the logical channel is allowed to be multiplexed with logical channel(s) with sl-HARQ-FeedbackEnabled.

In some arrangements, for the first UE, in response to determining that the anomaly state is detected on a carrier, the recovery signaling triggered by the anomaly state is transmitted on this carrier.

In some arrangements, for the first UE, in response to determining that recovery signaling is received on one carrier, the first UE transmits the response signaling on the same carrier.

In some arrangements, in performing LCP, the data object used by first UE for selecting a destination having the data object meets at least one of: the anomaly state is detected on a carrier comprising the SL grant, the data object is recovery signaling triggered by anomaly state detected on this carrier; or the anomaly state is detected on the carrier comprising the SL grant, the data object is recovery response signaling in response to the recovery signaling triggered by anomaly state detected on this carrier.

In some arrangements, in performing LCP, the data object belonging to a selected destination is selected or the destination having a data object is selected to be transmitted in response to determining that the data object meet at least one of: the anomaly state is detected on a carrier comprising the SL grant, the data object is recovery signaling triggered by anomaly state detected on this carrier; the anomaly state is detected on the carrier comprising the SL grant, the data object is response signaling in response to the recovery signaling triggered by anomaly state detected on this carrier. The data object is selected to be transmitted in response to determining that the data object meets at least one of: the anomaly state is detected on a carrier comprising the SL grant, the data object is recovery signaling triggered on the carrier; or the anomaly state is detected on the carrier comprising the SL grant, the data object is recovery response signaling in response to the recovery signaling triggered on the carrier

In some arrangement, the first UE transmits the recovery signaling on the carriers on which the recovery signaling is triggered.

In some arrangement, the second UE transmits the response signaling on the carrier on which the second UE receives the recovery signaling triggering the response signaling.

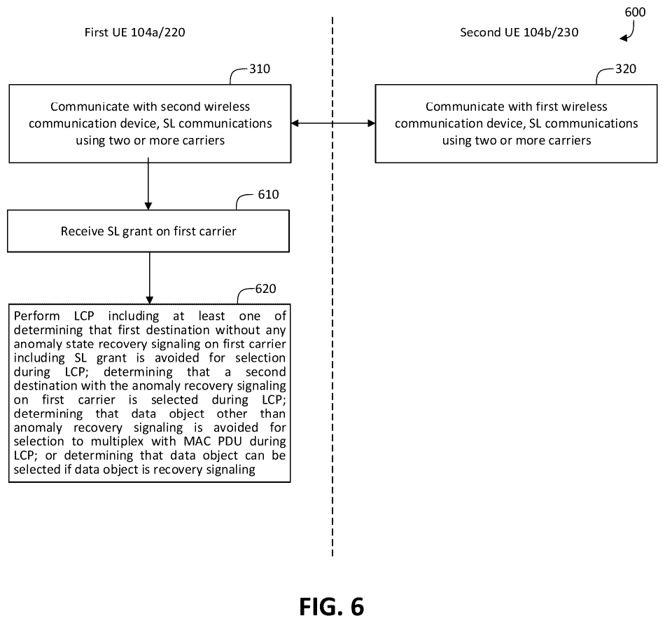

FIG. 6 is a flowchart diagram illustrating an example method 600 for detecting anomaly state in CA-based SL wireless communications, according to various arrangements. Referring to FIGS. 1A-6, the method 600 can be performed by a first UE (e.g., the UE 104a/220) and a second UE (e.g., the UE 104b/230). Communication via the SL wireless communication channel 170 or SL network is shown as cross the dashed line.

At 310, as described, the first UE communicates with the second UE SL communications. At 320, as described, the second UE communicates with the first UE SL communications. For example, the first UE and the second UE are sending and receiving signals and data to each other.

At 610, the first UE receives the SL grant on the first carrier. After receiving the SL grant, the first UE performs the LCP, including at 620. For example, at 620, the first UE performs at least one of at least one of: determining that a first destination without any anomaly state recovery signaling on the first carrier including the SL grant is avoided for selection during LCP, determining that a second destination with the anomaly state recovery signaling on the first carrier is selected during LCP, or determining that data object other than the anomaly state recovery signaling is avoided for selection to multiplex with MAC PDU during LCP, or determining that data object can be selected if the data object is recovery signaling. For example, during LCP, in response to the anomaly state being detected on the first carrier on which the SL grant belongs, a destination without anomaly state-recovery signaling should not be selected by the first UE for the SL grant. During LCP, in response to the anomaly state being detected on the first carrier on which the SL grant belongs, a destination having anomaly state-recovery signaling can be selected by the first UE for the SL grant. During LCP, in response to the anomaly state being detected on the first carrier on which the SL grant belongs, data object except anomaly state recovery signaling are not selected by the first UE to be multiplexed into the MAC PDU for the SL grant.

In some examples, during LCP, in response to the anomaly state being not detected on a carrier (e.g., a second carrier of the one or more carriers) on which the SL grant belongs, logical channels or MAC CEs can be selected to be multiplexed into the MAC PDU for the SL grant. In some examples, during LCP, in response to the anomaly state being not detected on a carrier (e.g., a second carrier of the one or more carriers) on which the SL grant belongs, logical channels or MAC CEs except anomaly state-recovery signaling can be selected by the first UE to be multiplexed into the MAC PDU for the SL grant.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according to arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below

What is claimed:

1. A wireless communication method, comprising:
communicating, by a first wireless communication device with a second wireless communication device, Sidelink (SL) communications; and
detecting, by the first wireless communication device, an anomaly state.

2. The wireless communication method of claim 1, wherein the anomaly state is detected on one carrier in response to detecting that an amount of absent feedback information reaches a maximum value.

3. The wireless communication method of claim 2, wherein detecting that the amount of the absent feedback information reaches the maximum value comprises one of:
a number of absent Physical Sidelink Feedback Channel (PSFCH) reception on at least one PSFCH reception resource reach a maximum absent PSFCH reception value;
a number of absent Hybrid Automatic Repeat Request (HARQ) feedback on at least one HARQ feedback resource reach a maximum absent HARQ feedback value;
the number of absent PSFCH reception on the at least one PSFCH reception resource reaches the maximum absent PSFCH reception value, and positive-negative acknowledgement is selected; or
the number of absent PSFCH reception on the at least one PSFCH reception resource reaches the maximum absent PSFCH reception value, and negative-only acknowledgement is selected.

4. The wireless communication method of claim 1, wherein the anomaly state is detected on one carrier in response to determining that a ratio of an amount of absent feedback information to an amount of intended feedback information reaches a maximum value.

5. The wireless communication method of claim 4, wherein determining that the amount of the ratio reaches a maximum value comprises one of:
determining that a ratio of a number of absent Physical Sidelink Feedback Channel (PSFCH) receptions on at least one PSFCH reception resource to a number of intended PSFCH receptions on the at least one PSFCH reception resource reaches a PSFCH ratio threshold, and positive-negative acknowledgement is selected; or
determining that a ratio of a number of absent Hybrid Automatic Repeat Request (HARQ) feedback on at least one HARQ feedback resource to a number of intended HARQ feedback on the at least one HARQ feedback resource reaches a HARQ feedback ratio threshold, and the positive-negative acknowledgement is selected.

6. The wireless communication method of claim 1, wherein the anomaly state is determined on one carrier in response to determining that Channel Busy Ratio (CBR) is higher than a threshold.

7. The wireless communication method of claim 1, wherein the anomaly state on at least one carrier or on one destination is detected in response to determining at least one of:
a number of retransmissions as indicated by a SL Radio Link Control (RLC) entity for a destination reach a retransmission maximum value; or
a number of retransmissions as indicated by a SL Media Access Control (MAC) entity for a destination reach a retransmission maximum value; or
a timer for Radio Resource Control (RRC) has expired; or
a number of consecutive Hybrid Automatic Repeat Request (HARQ) Discontinuous Transmission (DTX) for the destination reach a HARQ DTX maximum value; or
integrity for at least one Radio Bearer (RB) for the destination has failed; or
a maximum transmission number of recovery signaling has been reached; or
the first wireless communication device has not receives a maximum number of response signaling; or
a number of absent Physical Sidelink Feedback Channel (PSFCH) reception on at least one PSFCH reception resource reach a maximum absent PSFCH reception value; or
a number of absent Hybrid Automatic Repeat Request (HARQ) feedback on at least one HARQ feedback resource reach a maximum absent HARQ feedback value.

8. The wireless communication method of claim 4, wherein the maximum value can be configured by at least one of: a network, or a second device.

9. The wireless communication method of claim 1, wherein in response to detecting the anomaly state, the first wireless communication device performs at least one of:
triggering carrier selection or reselection; or
dropping grant configured for each of the at least one first carrier; or
reporting the anomaly state, detected on a carrier, to a network; or
triggering a recovery procedure for the carrier on which the anomaly state is detected; or
triggering a recovery procedure for a destination on which the anomaly state is detected; or
triggering a reporting procedure.

10. The wireless communication method of claim 2, further comprising in response to determining that the anomaly state is detected on all carriers for the SL communications for the second wireless communication device, the first wireless communication device performs at least one of:
releasing Radio Resource Control (RRC) connection with the second wireless communication device;
reporting to a network that the RRC connection with the second wireless communication device has been released due to the anomaly state; or
reporting to a network that the anomaly state is detected for the second wireless communication device; or
determining that a radio link failure (RLF) is detected for the second wireless communication device for the destination.

11. The wireless communication method of claim 9, wherein in response to triggering the recovery procedure, the first wireless communication device performs at least one of:
starting a timer; or
transmitting a recovery signaling; or
receiving a response signaling; or
receiving an indication.

12. The wireless communication method of claim 11, further comprising, in response to the first wireless communication device considering the recovery procedure is at least one of: a success or a failure, stopping the timer initiated responsive to the recovery procedure being triggered.

13. The wireless communication method of claim 11, wherein receiving the indication corresponding to recovering the first carrier from the anomaly state comprises at least one of:
receiving, by the first wireless communication device from a network, a first activation indication indicating activating the first carrier;
receiving, by the first wireless communication device from the network, a first recovery indication indicating recovering the first carrier;
receiving, by the first wireless communication device from the second wireless communication device, a second activation indication indicating activating the first carrier;
receiving, by the first wireless communication device from the second wireless communication device, a second recovery indication indicating recovering the first carrier; or
receiving, by the first wireless communication device from the network, a SL carrier list used for SL communication including this first carrier detecting the anomaly state.

14. The wireless communication method of claim 1, wherein the anomaly state comprises a Radio Link Failure (RLF), or
is comprised in at least one of a network or a peer user equipment.

15. A first wireless communication device, comprising:
at least one processor configured to:
communicate, via a transceiver with a second wireless communication device, Sidelink (SL) communications; and
detect an anomaly state.

16. The first wireless communication device of claim 15, wherein the anomaly state is detected on one carrier in response to detecting that an amount of absent feedback information reaches a maximum value.

17. The first wireless communication device of claim 16, wherein detecting that the amount of the absent feedback information reaches the maximum value comprises one of:
a number of absent Physical Sidelink Feedback Channel (PSFCH) reception on at least one PSFCH reception resource reach a maximum absent PSFCH reception value;
a number of absent Hybrid Automatic Repeat Request (HARQ) feedback on at least one HARQ feedback resource reach a maximum absent HARQ feedback value;
the number of absent PSFCH reception on the at least one PSFCH reception resource reaches the maximum absent PSFCH reception value, and positive-negative acknowledgement is selected; or
the number of absent PSFCH reception on the at least one PSFCH reception resource reaches the maximum absent PSFCH reception value, and negative-only acknowledgement is selected.

18. The first wireless communication device of claim 15, wherein the anomaly state is detected on one carrier in response to determining that a ratio of an amount of absent feedback information to an amount of intended feedback information reaches a maximum value.

19. The first wireless communication device of claim 18, wherein determining that the amount of the ratio reaches a maximum value comprises one of:
determining that a ratio of a number of absent Physical Sidelink Feedback Channel (PSFCH) receptions on at least one PSFCH reception resource to a number of intended PSFCH receptions on the at least one PSFCH reception resource reaches a PSFCH ratio threshold, and positive-negative acknowledgement is selected; or
determining that a ratio of a number of absent Hybrid Automatic Repeat Request (HARQ) feedback on at least one HARQ feedback resource to a number of intended HARQ feedback on the at least one HARQ feedback resource reaches a HARQ feedback ratio threshold, and the positive-negative acknowledgement is selected.

20. The first wireless communication device of claim 15, wherein the anomaly state is determined on one carrier in response to determining that Channel Busy Ratio (CBR) is higher than a threshold.
